(19) United States
(12) Patent Application Publication
(10) Pub. No.: US 2019/0033832 A1
(43) Pub. Date: Jan. 31, 2019

(54) USABILITY ENHANCEMENTS FOR CNC TOOLS

(71) Applicant: INOVATECH ENGINEERING CORP., Vankleek Hill (CA)

(72) Inventors: MIGUEL CLEMENT, VANKLEEK HILL (CA); STEPHANE MENARD, VANKLEEK HILL (CA); DOMINIQUE BRUNEAU, VANKLEEK HILL (CA); DAVID GABRIELS, VANKLEEK HILL (CA)

(21) Appl. No.: 16/044,928

(22) Filed: Jul. 25, 2018

Related U.S. Application Data
(60) Provisional application No. 62/536,700, filed on Jul. 25, 2017.

(51) Int. Cl. G05B 19/418

(52) U.S. Cl. CPC G05B 19/4181; G05B 2219/32128; G05B 2219/34376

(57) ABSTRACT

Computer numerical control (CNC) machines execute a process automatically unless a condition occurs that triggers one or more alarms that terminate the process. Accordingly, CNC laser cutting post-process inspection is usually non-existent or minimal. However, with CNC laser welding it is more common for a visual inspection or automated inspection to be performed to verify that the process was completed. Similar issues occur when single piece parts are required in addition to which executing an offline inspection requires additional complexity in re-working any piece part. Accordingly, embodiments of the invention provide enterprises and facilities employing CNC laser cutting/welding systems with a means to overcome these limitations. Further, providing intuitive user interfaces allows the user to perform tasks directly through a touch screen interface they are viewing the work piece/piece-parts upon.

### CROSS-REFERENCE TO RELATED APPLICATIONS

This patent application claims the benefit of U.S. Provisional Patent Application 62/536,700 filed Jul. 25, 2017 entitled “Usability Enhancements for CNC Tools”, the entire contents of which are incorporated herein by reference.

### FIELD OF THE INVENTION

This invention relates to computer numerical control machine tools and more particularly to the usability enhancements relating to asynchronous communications and piece-part placement.

### BACKGROUND OF THE INVENTION

Numerical control (NC) is the automation of machine tools that are operated by precisely programmed commands encoded on a storage medium, as opposed to controlled manually via hand wheels or levers, or mechanically automated via cams alone. Most NC today is computer (or computerized) numerical control (CNC), in which local and/or remote computers provide the data files for execution by the machine tool(s). CNC systems allow end-to-end component design to highly automated using computer-aided design (CAD) and computer-aided manufacturing (CAM) programs. The programs produce a computer file that is interpreted to extract the commands needed to operate a particular machine via a post processor, and then loaded into the CNC machines for production.

As a particular component might require the use of a number of different tools, e.g. drills, saws, etc., modern machines often combine multiple tools into a single “cell”. In other installations, a number of different machines are used with an external controller and human or robotic operators move the component from machine to machine. In either case, the series of steps needed to produce any part is highly automated and produces a part that closely matches the original CAD design.

This has made CNC based manufacturing a common foundation to many high volume products. Accordingly, the time taken for the CNC machine(s) to execute the sequence of processes becomes a dominant factor in the cost and throughput of a CNC production station and/or CNC production line. It would, therefore, be beneficial to reduce the total time processing as well as provide for increased options to adjust CNC processing within the sequence of a single piece-part and/or identify the piece-part as scrap thereby improving yields and/or reducing unproductive CNC machine time.

However, in many environments CNC machine(s) are not always employed in highly repetitive high volume manufacturing but are employed due to the manufacturing technology they exploit such as laser cutting, laser welding, etc. Within these environments a piece-part may be machined once or a small number of times and whilst improving CNC tool utilization aids the enterprise in increasing productivity it would be beneficial for the CNC tool to allow for raw material to be an offcut, a remaining section of a sheet, etc. Accordingly, it would be beneficial to allow the CNC machine and/or tool operator an ability to manipulate the control sequence (commonly referred to as a control file or job file) to allow it to be processed upon offcuts, partial sheets, etc. Further, as such offcuts, partial sheets etc. are typically incompatible with robotic handling, automated placement etc. or even having common reference edges between elements of raw material it would be beneficial to provide manipulation of the control file spatially to process the required piece-part.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to computer numerical control machine tools and more particularly to the usability enhancements relating to asynchronous communications and piece-part placement.

In accordance with an embodiment of the invention there is provided a method comprising:
retrieving a control file for transmission to a computer numerical control (CNC) machine;
dividing the control file into a plurality N control sub-files, wherein N≥3 and N is an integer;
transmitting the first control file;
transmitting the second control file;
receiving a complete signal for the first control file; and
modifying and transmitting the third control file in dependence upon the complete signal for the first control file.

In accordance with an embodiment of the invention there is provided a method comprising:
a) retrieving a control file for transmission to a computer numerical control (CNC) machine comprising a plurality N control lines, wherein N≥3 and N is an integer;
b) transmitting control lines until a first complete signal is received;
c) modifying and transmitting subsequent control lines in dependence upon the received first complete signal;
d) receiving further complete signals;
e) modifying and transmitting subsequent control lines in dependence upon the last complete signal until a new complete signal is received; and
f) continuing until the control file has been sent.

In accordance with an embodiment of the invention there is provided a method comprising:
a) establishing upon a computer numerical control (CNC) machine file a control file for execution relating to a piece part to be formed from a piece of raw material;
b) establishing upon the CNC machine a corner of the piece of raw material;
c) establishing a kerf relating to forming the piece part;
d) executing an inspection sequence of the piece of raw material based upon the external contour of the piece part defined by the control file and the kerf;
e) determining whether the external contour of the piece part fits within the piece of raw material;
f) upon a positive determination forming the piece part from the piece of raw material.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a network environment within which embodiments of the invention may be employed;

FIG. 2 depicts a machine shop hub supporting communications to a network such as depicted in FIG. 1 and as supporting embodiments of the invention with respect to machine tool settings and profiles;

FIG. 3 depicts exemplary plasma cutting machine tool systems generating and exploiting configuration settings established and verified according to embodiments of the invention;

FIG. 4 depicts a schematic diagram of a welding-inspection sequence upon a CNC laser welding system according to an embodiment of the invention;

FIG. 5 depicts start and stop images of a CNC machining system executing a control protocol according to the prior art versus a faster control protocol according to an embodiment of the invention;

FIG. 6 depicts a control protocol between controller and CNC machine according to the prior art;

FIGS. 7A and 7B depict a control protocol according to an embodiment of the invention between controller and CNC machine;

FIGS. 8A and 8B depict a control protocol according to an embodiment of the invention between controller and CNC machine;

FIG. 9 depicts a CNC process according to the prior art based upon defined raw material and CNC tooling;

FIG. 10 depicts a CNC process according to an embodiment of the invention wherein variable raw material can be handled without defined CNC tooling;

FIG. 11 depicts screenshots of an exemplary corner location/definition stage of the CNC process described in respect of FIG. 10;

FIG. 12 depicts screenshots of an exemplary piece-part boundary definition stage of the CNC process described in respect of FIG. 10; and

FIG. 13 depicts screenshots of an exemplary piece-part control file manipulation process stage of the CNC process described in respect of FIG. 10.

### DETAILED DESCRIPTION

The present invention is directed to computer numerical control machine tools and more particularly to the usability enhancements relating to asynchronous communications and piece-part placement.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users. Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, a wearable device and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

A “server” as used herein, and throughout this disclosure, refers to one or more physical computers co-located and/or geographically distributed running one or more services as a host to users of other computers, PEDs, FEDs, etc. to serve the client needs of these other users. This includes, but is not limited to, a database server, file server, mail server, print server, web server, gaming server, or virtual environment server.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “third party” or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals. This includes, but is not limited to, private individuals, employees of organizations and/or enterprises, members of community organizations, members of charity organizations, men and women. In its broadest sense the user may further include, but not be limited to, software systems, mechanical systems, robotic systems, android systems, etc. that may be characterised by an ability to exploit one or more embodiments of the invention. A user may be associated with biometric data which may be, but not limited to, monitored, acquired, stored, transmitted, processed and analysed either locally or remotely to the user. A user may also be associated through one or more accounts and/or profiles with one or more of a service provider, third party provider, enterprise, social network, social media etc. via a dashboard, web service, website, software plug-in, software application, and graphical user interface (GUI).

“User information” as used herein may refer to, but is not limited to, user behavior information and/or user profile information. It may also include a user's biometric information, an estimation of the user's biometric information, or a projection/prediction of a user's biometric information derived from current and/or historical biometric information.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XML, XHTML, PDF, XLS, SVG, WMA, MP4, FLV, and PPT, for example, as well as others, see for example http://en.wikipedia.org/wiki/List_of_file_formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

A “machine tool” (tool) as used herein, and throughout this disclosure, refers to a machine for shaping or machining or assembling metal or other rigid materials, usually by cutting, boring, drilling, grinding, shearing, or other forms of deformation in conjunction with welding, brazing and other forms of material joining. Machine tools employ some sort of tool that does the cutting or shaping which may be fixed or removable/changeable. Machine tools generally have some means of constraining the workpiece and/or providing a guided movement of the parts of the machine and workpiece. Thus the relative movement between the workpiece and the cutting tool (which is called the toolpath) is controlled or constrained by the machine to at least some extent. Some machine tools may work on a single piece part at a time whilst others may work on multiple piece parts or generate multiple piece parts from a single piece of starting stock material. Some machine tools may only provide a single process, e.g. drilling, whilst other tools such as milling machines may provide multiple processes. Such machine tools may include, but not be limited to, drill presses, lathes, screw machines, milling machines, shears, saws, planers, grinding machines, electrical discharge machining, plasma cutters, laser cutters, laser engravers, grinders, electrical discharge welders, shot peening, and water jet cutters/surface machining.

A “profile” as used herein, and throughout this disclosure, refers to a computer and/or microprocessor readable data file comprising data relating to settings and/or limits and/or sequence for a machine tool or other item of manufacturing equipment.

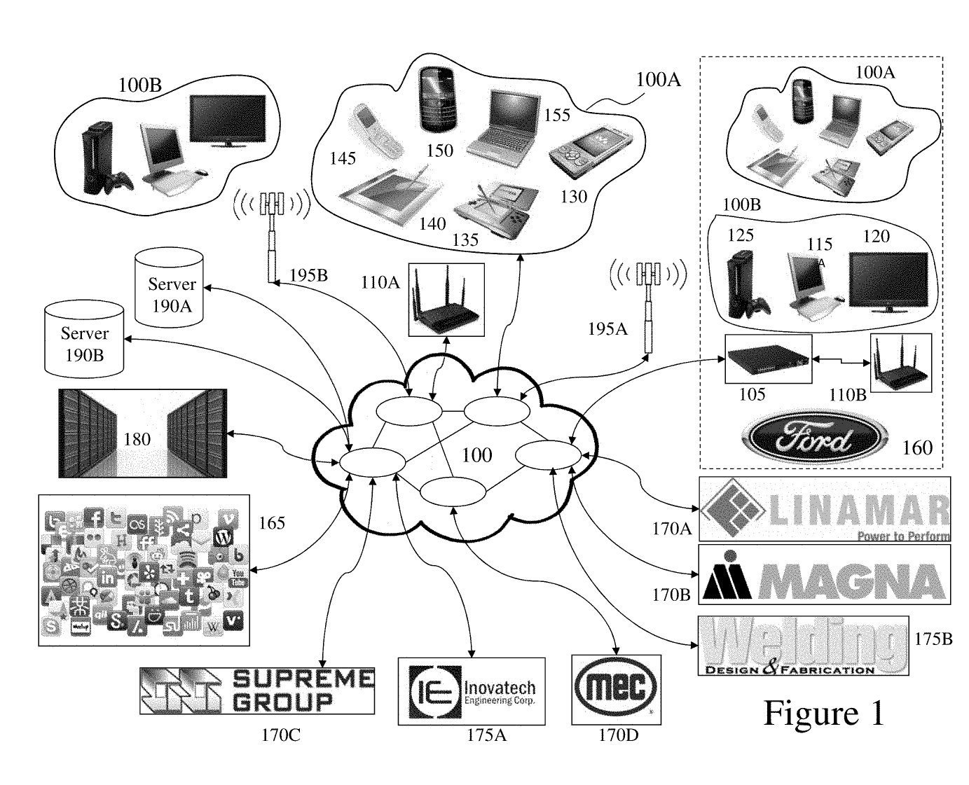

Referring to FIG. 1 there is depicted a network environment 100 within which embodiments of the invention may be employed supporting machine tool systems, applications, and platforms (MTSAPs) according to embodiments of the invention. Such MTSAPs, for example supporting multiple channels and dynamic content. As shown first and second user groups 100A and 100B respectively interface to a telecommunications network 100. Within the representative telecommunication architecture, a remote central exchange 180 communicates with the remainder of a telecommunication service providers network via the network 100 which may include for example long-haul OC-48/OC-192 backbone elements, an OC-48 wide area network (WAN), a Passive Optical Network, and a Wireless Link. The central exchange 180 is connected via the network 100 to local, regional, and international exchanges (not shown for clarity) and therein through network 100 to first and second cellular APs 195A and 195B respectively which provide Wi-Fi cells for first and second user groups 100A and 100B respectively. Also connected to the network 100 are first and second Wi-Fi nodes 110A and 110B, the latter of which being coupled to network 100 via router 105. Second Wi-Fi node 110B is associated with Enterprise 160, such as Ford™ for example, within which other first and second user groups 100A and 100B are disposed. Second user group 100B may also be connected to the network 100 via wired interfaces including, but not limited to, DSL, Dial-Up, DOCSIS, Ethernet, G.hn, ISDN, MoCA, PON, and Power line communication (PLC) which may or may not be routed through a router such as router 105.

Within the cell associated with first AP 110A the first group of users 100A may employ a variety of PEDs including for example, laptop computer 155, portable gaming console 135, tablet computer 140, smartphone 150, cellular telephone 145 as well as portable multimedia player 130. Within the cell associated with second AP 110B are the second group of users 100B which may employ a variety of FEDs including for example gaming console 125, personal computer 115 and wireless/Internet enabled television 120 as well as cable modem 105. First and second cellular APs 195A and 195B respectively provide, for example, cellular GSM (Global System for Mobile Communications) telephony services as well as 3G and 4G evolved services with enhanced data transport support. Second cellular AP 195B provides coverage in the exemplary embodiment to first and second user groups 100A and 100B. Alternatively the first and second user groups 100A and 100B may be geographically disparate and access the network 100 through multiple APs, not shown for clarity, distributed geographically by the network operator or operators. First cellular AP 195A as show provides coverage to first user group 100A and environment 170, which comprises second user group 100B as well as first user group 100A. Accordingly, the first and second user groups 100A and 100B may according to their particular communications interfaces communicate to the network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 100A may form associations either through standards such as IEEE 802.15 and Bluetooth as well in an ad-hoc manner.

Also connected to the network 100 are Social Networks (SOCNETS) 165, first manufacturer 170A, e.g. Linamar™; second manufacturer 170B, e.g. Magna™; steel fabricator 170C, e.g. Supreme Group™; manufacturing solutions provider 170D, e.g. Mayville Engineering Corp.; machine tool manufacturer 175A, e.g. Inovatech Engineering; and online chat/discussion/bulletin board/forum 175B, e.g. Welding Design and Fabrication (http://weldingweb.com/); as well as first and second servers 190A and 190B which together with others, not shown for clarity. Accordingly, a user employing one or more MTSAPs may interact with one or more such providers, enterprises, service providers, retailers, third parties etc. and other users. First and second servers 190A and 190B may host according to embodiments of the inventions multiple services associated with a provider of adult device systems, applications, and platforms (MTSAPs); a provider of a SOCNET or Social Media (SOME) exploiting MTSAP features; a provider of a SOCNET and/or SOME not exploiting MTSAP features; a provider of services to PEDS and/or FEDS; a provider of one or more aspects of wired and/or wireless communications; an Enterprise 160 exploiting MTSAP features; license databases; content databases; image databases; content libraries; customer databases; websites; and software applications for download to or access by FEDs and/or PEDs exploiting and/or hosting MTSAP features. First and second primary content servers 190A and 190B may also host for example other Internet services such as a search engine, financial services, third party applications and other Internet based services.

Accordingly, a user may exploit a PED and/or FED within an Enterprise 160, for example, and access one of the first or second primary content servers 190A and 190B respectively to perform an operation such as accessing/downloading an application which provides MTSAP features according to embodiments of the invention; execute an application already installed providing MTSAP features; execute a web based application providing MTSAP features; or access content. Similarly, a user may undertake such actions or others exploiting embodiments of the invention exploiting a PED or FED within first and second user groups 100A and 100B respectively via one of first and second cellular APs 195A and 195B respectively and first Wi-Fi nodes 110A.

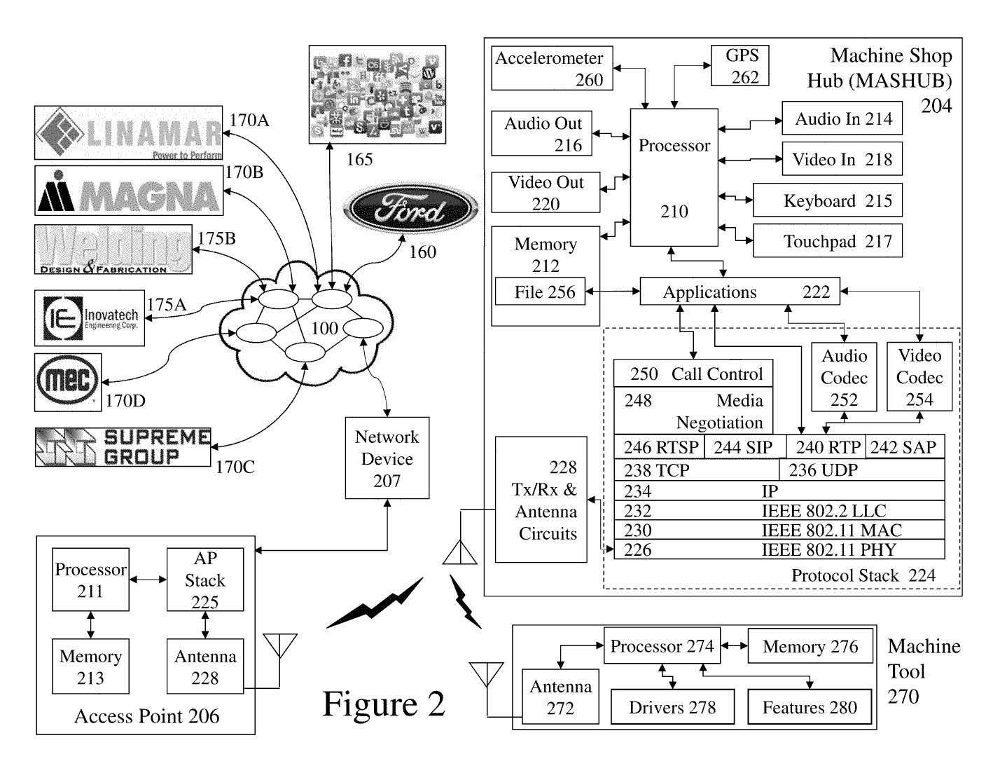

Now referring to FIG. 2 there is depicted a Machine Shop Hub (MASHUB) 204 and network access point 207 supporting MTSAP features according to embodiments of the invention. MASHUB 204 may, for example, be a PED and/or FED and may include additional elements above and beyond those described and depicted. Also depicted within the MASHUB 204 is the protocol architecture as part of a simplified functional diagram of a system 200 that includes an MASHUB 204, such as a smartphone 155, an access point (AP) 206, such as first AP 110, and one or more network devices 207, such as communication servers, streaming media servers, and routers for example such as first and second servers 190A and 190B respectively. Network devices 207 may be coupled to AP 206 via any combination of networks, wired, wireless and/or optical communication links such as discussed above in respect of FIG. 1 as well as directly as indicated. Network devices 207 are coupled to network 100 and therein Social Networks (SOCNETS) 165, first manufacturer 170A, e.g. Linamar™; second manufacturer 170B, e.g. Magna™; steel fabricator 170C, e.g. Supreme Group™; manufacturing solutions provider 170D, e.g. Mayville Engineering Corp.; machine tool manufacturer 175A, e.g. Inovatech Engineering; and online chat/discussion/bulletin board/forum 175B, e.g. Welding Design and Fabrication (http://weldingweb.com/); as well as first and second servers 190A and 190B and Enterprise 160, Ford™.

The MASHUB 204 includes one or more processors 210 and a memory 212 coupled to processor(s) 210. AP 206 also includes one or more processors 211 and a memory 213 coupled to processor(s) 210. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

MASHUB 204 may include an audio input element 214, for example a microphone, and an audio output element 216, for example, a speaker, coupled to any of processors 210. MASHUB 204 may include a video input element 218, for example, a video camera or camera, and a video output element 220, for example an LCD display, coupled to any of processors 210. MASHUB 204 also includes a keyboard 215 and touchpad 217 which may for example be a physical keyboard and touchpad allowing the user to enter content or select functions within one of more applications 222. Alternatively, the keyboard 215 and touchpad 217 may be predetermined regions of a touch sensitive element forming part of the display within the MASHUB 204. The one or more applications 222 that are typically stored in memory 212 and are executable by any combination of processors 210. MASHUB 204 also includes accelerometer 260 providing three-dimensional motion input to the process 210 and GPS 262 which provides geographical location information to processor 210.

MASHUB 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise, AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Tx/Rx & Antenna Circuits 228, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238. Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206.

Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230. It would be apparent to one skilled in the art that elements of the MASHUB 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed MASHUBs represented by MASHUB 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Also depicted is Machine Tool (MACTO) 270 which is coupled to the MASHUB 204 through a wireless interface between Antenna 272 and Tx/Rx & Antenna Circuits 228 wherein the MASHUB 204 may support, for example, a national wireless standard such as GSM together with one or more local and/or personal area wireless protocols such as IEEE 802.11 a/b/g WiFi, IEEE 802.16 WiMAX, and IEEE 802.15 Bluetooth for example. The Antenna 272 is connected to Processor 274 and therein to Memory 276, Drivers 278, and Features 280. Accordingly, the MACTO 270 may operate as standalone device with factory installed control routines accessed through an interface on the MACTO 270, not shown for clarity, or through an application in execution upon the MASHUB 204. Subsequently, as described below one or more of these control routines may be modified, amended, deleted etc. whilst other new control routines may be created, acquired, installed etc.

Accordingly, it would be evident to one skilled the art that the MACTO 270 with associated MASHUB 204 may accordingly download original software and/or revisions for a variety of functions supported by the drivers 278 and/or features 280. In some embodiments of the invention the functions may not be implemented within the original as sold MACTO 270 and are only activated through a software/firmware revision and/or upgrade either discretely or in combination with a subscription or subscription upgrade for example. Whilst the MASHUB 204, MACTO 270 and AP 206 are depicted exploiting wireless communications it would be evident that in other embodiments of the invention one or more of these wireless communication paths may be replaced with a wired connection or a non-wireless but unwired connection such as an optical link for example or not implemented and communications are through the AP 206 for example between MACTO 270 and MASHUB 204 or even via the network 100.

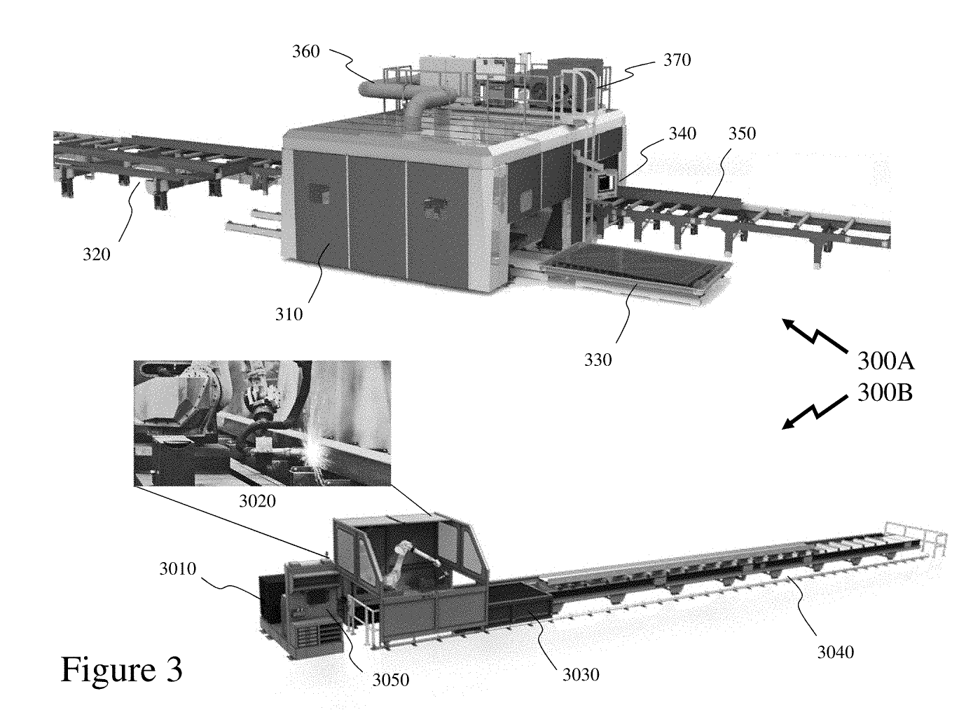

Now referring to FIG. 3 there are depicted first and second schematics 300A and 300B of plasma cutting machine tool systems as manufactured by Inovatech Engineering which may generate and exploit machine tool settings/configuration profiles as established, verified, and acquired according to embodiments of the invention. Accordingly, each of the plasma cutting machine tool systems in first and second schematics 300A and 300B may be an example of a MACTO 270 in FIG. 2. Considering initially first schematic 300A then:
Robot enclosure 310, provides an environment containing fumes, reducing noise etc.;
Cross-transfer 320, allows different load/unload profiles to be employed as well as materials receipt/processed material delivery, etc. and saves time;
Plate table 330, provides base for sheet/plate as moved relative to plasma cutter where typical configurations include 6″×10″ (2 m×3 m), 12′×10′ (4 m×3 m), and 24′×10″ (8 m×3 m);
Operator station 340, wherein an industrial computer controls plasma robot, conveyors, plate table, etc. and displays messages, alarms, maintenance screens, plasma control settings etc.;
Infeed/outfeed conveyors 350; chain or belt driven conveyors allow material to be received from stock/prior MACTO 270 and/or transferred to finished stock/next MACTO 270.
Ventilation system 360, which provides automatic fume extraction and filtering etc.; and
Plasma gas control etc. 370, with automated gas control etc. for different cutting processes adapted to plasma cutter head, material processed, etc.

Now referring to second schematic 300B then:
Plasma gas control etc. 3010, with automated gas control etc. for different cutting processes adapted to plasma cutter head, material processed, etc.
6-axis robot 3020, with plasma cutter head allowing control over head position, orientation and movement of plasma cutter head relative to the piece part independent of any motion of the piece part which as depicted is within an enclosure that moves along the profile table 3040 reducing overall space requirements;
Water 3030, optionally inserted in line for quenching, cutting stiffener plates, etc.;
Profile table 3040 which supports the piece-part(s) and allows for laser piece-part scanning and alignment of the piece-part on the profile table; and
Operator station 3050, wherein an industrial computer controls plasma robot, conveyors, plate table, etc. and displays messages, alarms, maintenance screens, plasma control settings etc.

Accordingly, the operator stations 340 and 3050 in first and second schematics 300A and 300B (hereinafter operator station), acting for example as MACTO 270 with optional communications to a central machine shop system, e.g. MASHUB 204, or acting a MASHUB 204 in a stand-alone configuration provides the required control settings to the computer controlled elements of the plasma cutting machine tool system such as robot (not shown for clarity), plasma cutting tool, and plate table for example. These may be selected from a menu of control setting profiles defined, for example, by product name/product serial number etc. stored upon the operator station or alternatively the operator station retrieves the control setting profile from a remote system such as MASHUB 204. Accordingly, when the operator triggers execution of a machine tool profile (MACPRO) that defines the control settings of the plasma cutting system, in this instance although it would be evident that the MACTO 270 may be any other machine tool accepting computer numerical control (CNC) etc., together with the motion sequence of the robot and plate table as well as in other instances cross-transfer 320, infeed/outfeed conveyors 350, profile table 3050, etc.

Laser welding systems operate through conduction welding or penetration laser welding. Conduction welding is performed at lower energy levels resulting in a wide and shallow weld nugget through either direct heating or absorption. In direct heat welding the heat flow within the work piece is governed by classical thermal conduction from the surface heat of the absorbed laser such that the weld is made by melting portions of the base material. This can be performed on a wide range of alloys and metals. In absorption welding energy is absorbed through inter-facial absorption wherein an absorbing ink is placed at the interface of a lap joint which absorbs the laser beam energy. This is then conducted into a limited thickness of the surrounding material to form a molten inter-facial film that solidifies as the welded joint. Butt welds can be made by directing the energy towards the joint line at an angle through material at one side of the joint, or from one end if the material is highly transmissive.

In contrast conduction-penetration welding occurs at medium energy density and results in further penetration of the weld into the material. Finally, keyhole mode welding creates a deep narrow weld within the material as the laser forms a filament of vaporized material known as a “keyhole” that extends into the material and provides a conduit for the laser energy to be efficiently delivered into the material. This direct delivery of energy into the material does not rely on conduction to achieve penetration, so it minimizes the heat into the material and reduces the heat affected zone.

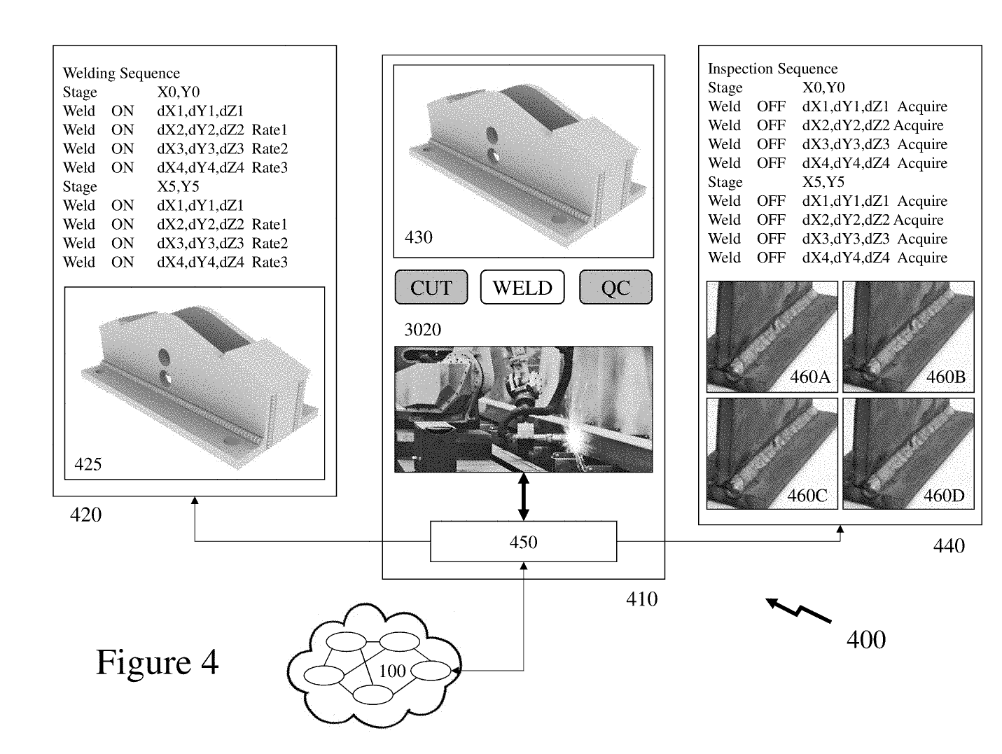

Referring to FIG. 4 there is depicted a schematic diagram 400 of a welding-inspection sequence upon a CNC laser welding system 410 according to an embodiment of the invention. As depicted the CNC laser welding system (CNC-LWS) 410 incorporates a 6-axis robot (6AX-R) 3020 coupled to a computer 450 and therein to the network 100. Accordingly, the user has selected to weld a piece-part 430 wherein the 6AX-R 3020 in conjunction with the table/platform upon which the piece-part 430 is mounted. Accordingly, in process 420 the CNC-LWS 410 executes the sequence of stage and welding movements as the laser welds the components 425 to form the piece-part 430. Subsequently, the CNC-LWS 410 executes an inspection sequence 440, quality control (QC), wherein the stage and welding movements are repeated but now the system directs its camera to acquire images of the welds which are depicted in first to fourth images 460A to 460D. These images may then be stored within a database in association with an identifier of the piece-part, which may be uniquely generated by the CNC-LWS 410 and cut into it during the welding process. These images and processing data for the piece-part may be locally stored or remotely stored on a remote server connected to the network 100.

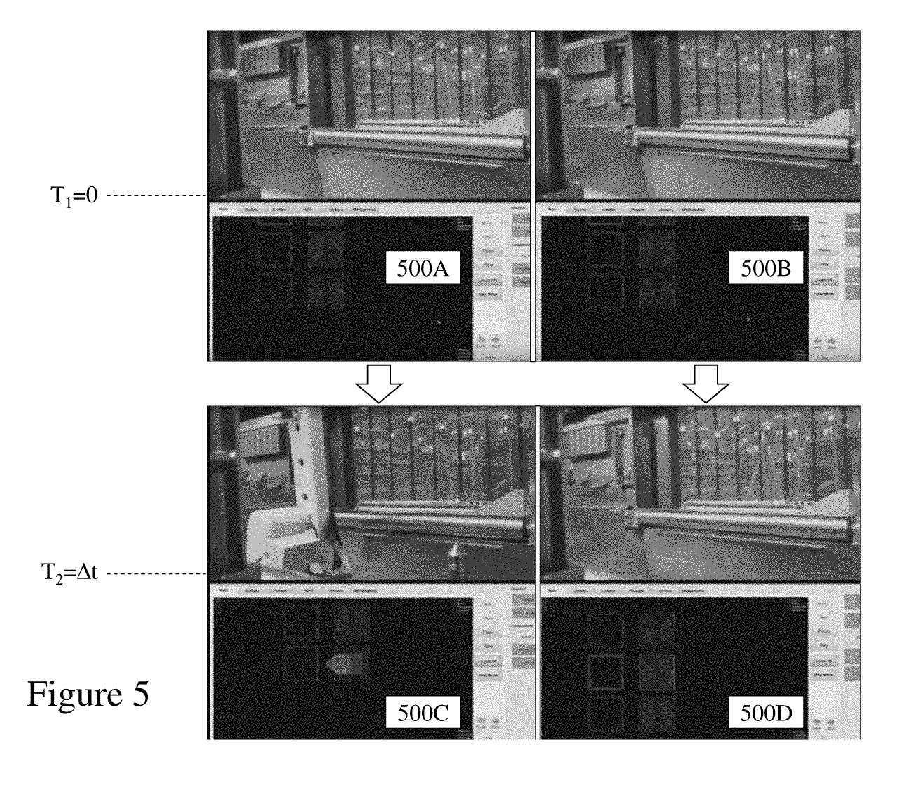

Now referring to FIG. 5 there are depicted first and second starting images 500A and 500B respectively depicting a CNC laser cutting-welding tool system in the upper half and a screenshot of a GUI of the CNC laser cutting-welding tool system. First image 500A representing a control protocol according to the prior art and second image 500B a control protocol according to an embodiment of the invention. In each instance the system is about to execute a process, i.e. T₁=0. Third and fourth images 500C and 500D depict the status of the system at a later point in time, T₂=Δt, where the protocol according to the embodiment of the invention has completed the process sequence but the prior art control protocol is still executing CNC tool movements and processes. For a process comprising:
Move from home to first location
Machine 3 holes with move between each
Profile each machined hole with move between;
Return to home location

The process with the prior art control sequence took 275 seconds whereas the process according to an embodiment of the invention took 183 seconds representing an improvement of 92 seconds. This being a 33% reduction in processing time against the prior art process.

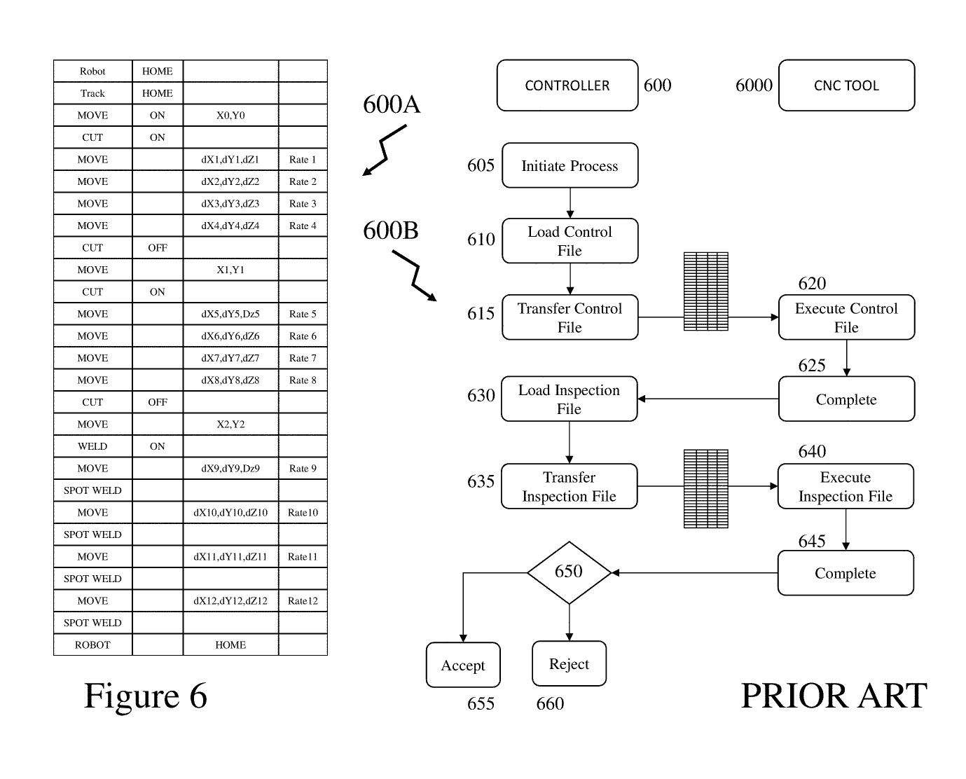

Referring to FIG. 6 there is depicted a process flow according to the prior art yielding the 275 second processing for the simple sequence in respect of FIG. 5. Table 600A depicts an exemplary control file structure comprising serial robot processes, e.g. “MOVE X0, Y0” being a CNC tool movement to absolute location “X0, Y0”, and laser process, e.g. “CUT ON” wherein the laser is set to a power setting for cutting the material on the tool bed wherein the laser is on until a “CUT OFF” command as opposed to “SPOT WELD” which is a defined duration laser processing at lower power setting than cutting. Accordingly, a control file defines the movements of the robot, settings of laser cutter-welder, etc. and may include other elements such as tool bed movement, for example.

Now referring to prior art process flow 600B a sequence of steps for the Controller 600 and CNC Tool 6000 are depicted starting with step 605 wherein the processing is initiated. Next in step 610 the process proceeds to load a control file which is then transferred in a single transfer to the CNC Tool 6000. The CNC Tool 6000 then executes this in step 620 and upon completion communicates to the Controller 600 in step 625. The Controller 600 then loads an inspection file is loaded in step 630 which is transferred in step 635 and executed in step 640 wherein data measured with the CNC Tool 6000 is then communicated back to the Controller 600 in step 645 upon completion. This data is then processed in step 650 to define the piece part as accepted wherein the process proceeds to step 655 or rejected wherein the process proceeds to step 660.

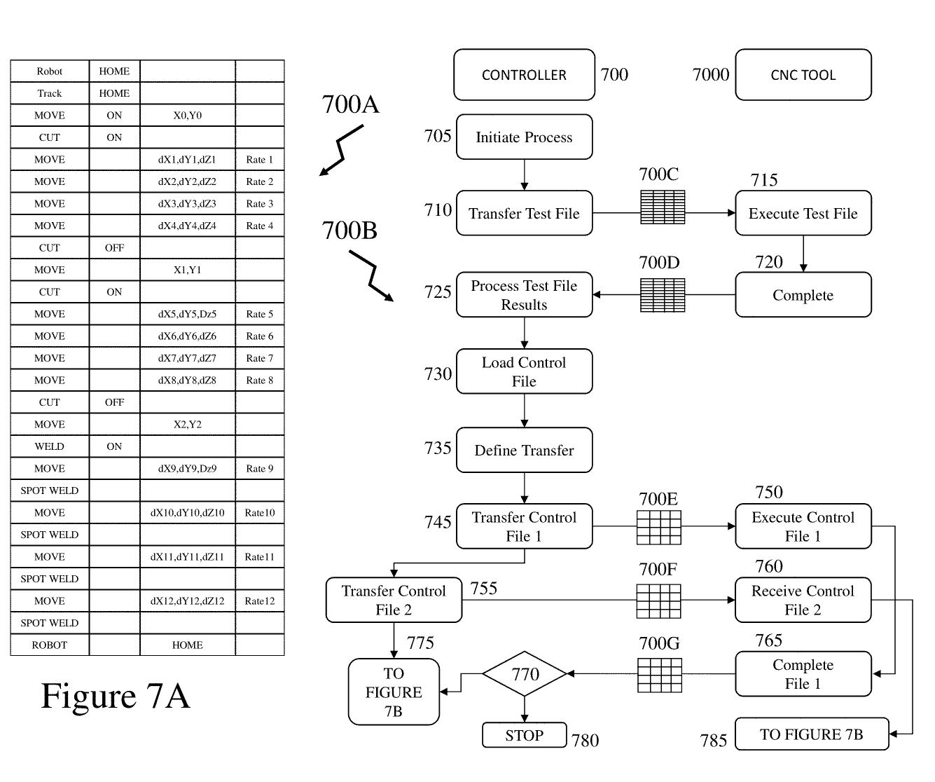

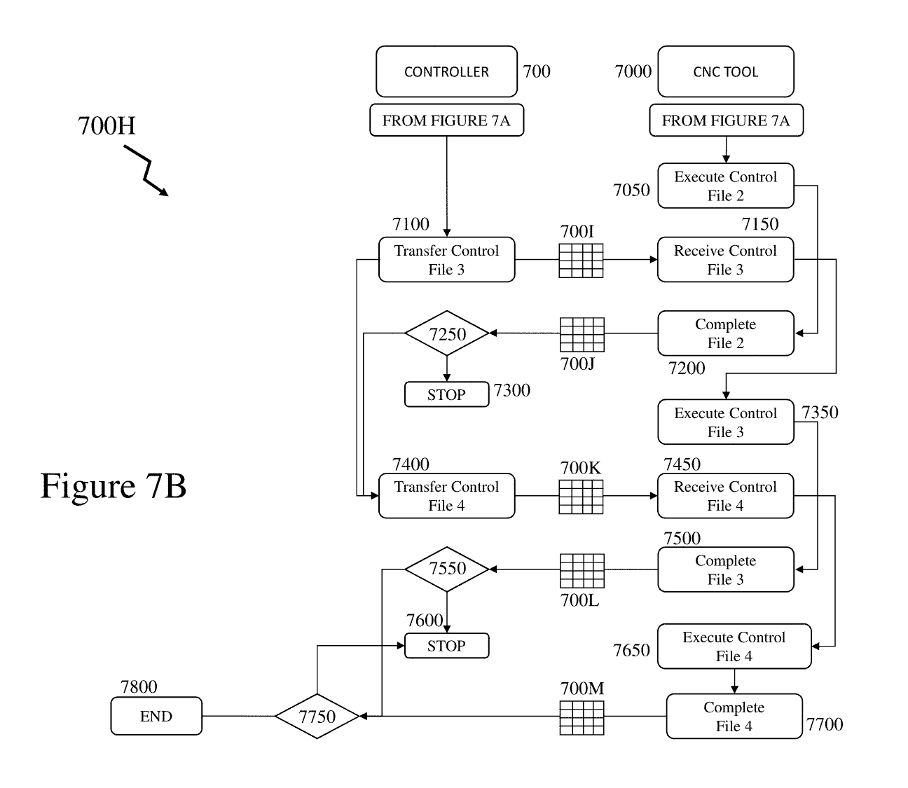

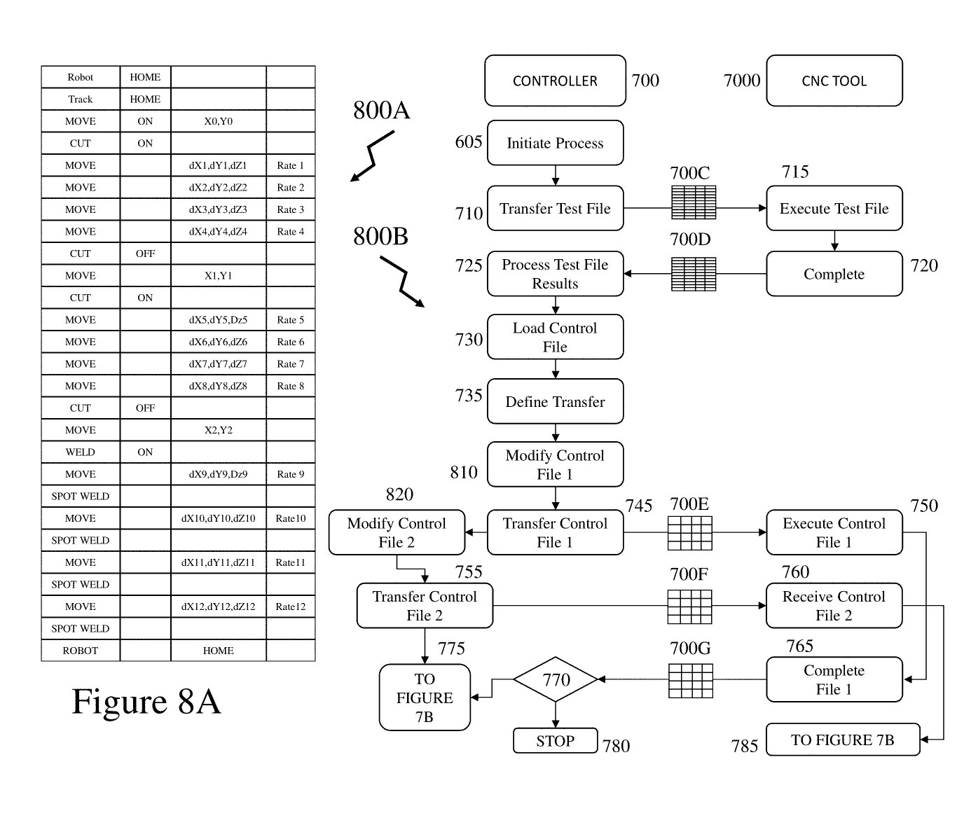

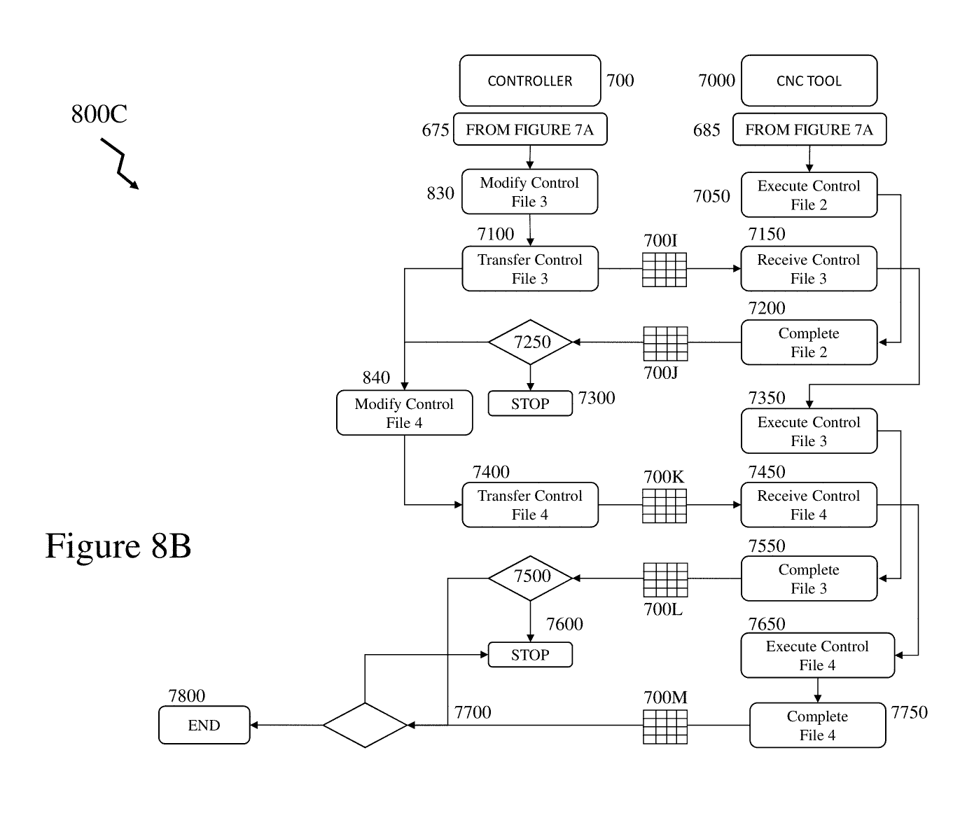

Referring to FIG. 7A there is depicted table 700A representing the control file such as depicted in FIG. 6. Also depicted is exemplary process flow 700B according to an embodiment of the invention defining a sequence of steps for a Controller 700 and CNC Tool 7000. The process flow 700B begins with step 705 in FIG. 7A wherein the processing is initiated. Next in step 710 the process proceeds to load a test file which is then transferred in a single transfer 700C to the CNC Tool 7000. The CNC Tool 7000 then executes this in step 715 and upon completion communicates to the Controller 700 in step 720 results file 700D. These test file results are processed in step 725 to define timing information relating to the CNC Tool 7000.

Next, the process flow 700B loads the control file in step 730 and defines the transfer sequence in step 735 in dependence upon the content of the control file and the test file results. Accordingly, the control file is partitioned into multiple files, within the embodiment described and depicted in respect of FIGS. 7A and 7B this being 4 although it may be 2, 3, 4, 5, to N (an integer) wherein files do not have to equal in size/processing steps but may vary according to the logical flow of the control file. As a result, in step 745 first control sub-file 700E is transferred and executed in step 750 but rather than waiting for completion the Controller 700 proceeds to transfer the second control sub-file 700F in step 755 which is received by the CNC Tool 7000. Upon completion of first control file 700E the CNC Tool 7000 transfers first results file 700G to the Controller 700 wherein it is processed in step 770 wherein the process may be halted by the process flow 700B proceeding to step 780 or proceeds to that depicted in FIG. 7B as does the flow for the Controller 700 from step 755 unless over-ridden by the stop process 780.

Accordingly, in FIG. 7B the steps depicted relate to the third and fourth control sub-files 700I and 700K and second to fourth results files 700J, 700L and 700M respectively. These steps being:
Step 7050—Execute second control sub-file;
Step 7100—Transfer third control sub-file 700I;
Step 7150—Receive third control sub-file 700I;
Step 7200—Complete second control sub-file 700F and transfer second result file 700J;
Step 7250—Process results and progress to stop in step 7300 or continue with step 7400;
Step 7350—Execute third control sub-file 7350;
Step 7400—Transfer fourth control sub-file 700K;
Step 7450—Receive fourth control sub-file 700K;
Step 7500—Complete third control sub-file 700I and transfer third result file 700L;
Step 7550—Process results and progress to stop in step 7600 or continue with step 7750;
Step 7650—Execute fourth control sub-file 700K;
Step 7700—Complete fourth control sub-file 700K and transfer fourth result file 700M;
Step 7750—Process results and progress to stop in step 7600 or continue to end in step 7800; and
Step 7800 wherein the process ends.

Now referring to FIG. 8A there is depicted table 800A representing the control file such as depicted in FIG. 6. Also depicted is exemplary process flow 800B according to an embodiment of the invention defining a sequence of steps for a Controller 700 and CNC Tool 7000. Exemplary process flow 800B continues as process flow 800C in FIG. 8B. As discussed in respect of FIGS. 7A and 7B multiple control sub-files are transferred rather than a single control file. Upon completion of executing each control sub-file a result file is transferred back to the Controller 700 for analysis as part of QA step at each executed control sub-file to determine whether the process should continue or terminate. A deficient sub-file execution triggering stopping of the process and termination of the piece-part within the exemplary embodiment of the invention depicted and described in respect of FIGS. 7A and 7B.

However, process flows 800B and 800C essentially mirror the same process flow as process flows 700B and 700C except that upon determining to proceed after analysis of each result file transferred the process performs a modification step to the next control sub-file. This modification reflecting adjustments necessary to the control file to allow for established results on the piece-part during processing. As depicted based upon transfer of the second control sub-file 700F during execution of the first control sub-file 700E no corrections are applied to the second control sub-file 700F but they can be applied to the third and fourth control sub-files 700I and 700K respectively. These additional steps being depicted as steps 830 and 840 respectively. Modification steps 810 and 820 are depicted within the process flow 800B in FIG. 8A for the first and second control sub-files 700E and 700F respectively based upon the executed test file wherein dimensional data is employed rather than the timing data which is employed in step 735 to define the transfer process of splitting the control file. The inventors refer to this communications protocol as “Async” in that transfer of control file information is not synchronized to any aspect of the CNC machine processing.

Within the process flow depicted in FIGS. 8A and 8B the process is depicted as comprising a sequence of receiving data from the CNC Tool 7000 after it completes a control sub-file and using this to modify the next control sub-file if appropriate, before transmitting it to the CNC Tool 7000 from the Controller 700. However, if the next complete signal is received from the CNC Tool 7000 prior to the modifications/revisions to the next control sub-file are complete the Controller 700 defaults to transmitting the next control sub-file unmodified.

Within another embodiment of the invention the process is fully “ad-hoc” in that the full control file is not sub-divided into predetermined control sub-files based upon determined timing information as described and depicted in respect of FIGS. 8A and 8B respectively. Rather the process comprises a sequence such as:
Transmit first control line;
Transmit second control line;
Receive complete for first control line;
Begin modifying third control line;
Begin modifying fourth control line unless complete signal received for second control line;
Etc.

In this manner, the process modifies as many control lines as it can before it is required to transmit the next control data.

Alternatively, the process may simply modify each control line in sequence based upon current modification data which evolves as each complete signal is received. Accordingly, such a process may comprise a sequence such as:
Process control lines and transmit each when ready;
Receive first complete signal;
Define first modification to control data;
Generate modified control line data with first modification until subsequent complete signal received indicating a change to a second modification is required; and
Sequentially progressing so that CNC Tool 7000 always has executed data with “the then best modification.”

Optionally, the controller may determine that only some control lines require modification and hence may transmit some without modifications and others with modifications. Optionally, a modification requiring increased processing may be delayed with transmission of other less sensitive control data not requiring modifications so that whilst the CNC Tool may execute the control lines out of sequence to that originally established those control lines requiring careful or substantial modification are processed accordingly.

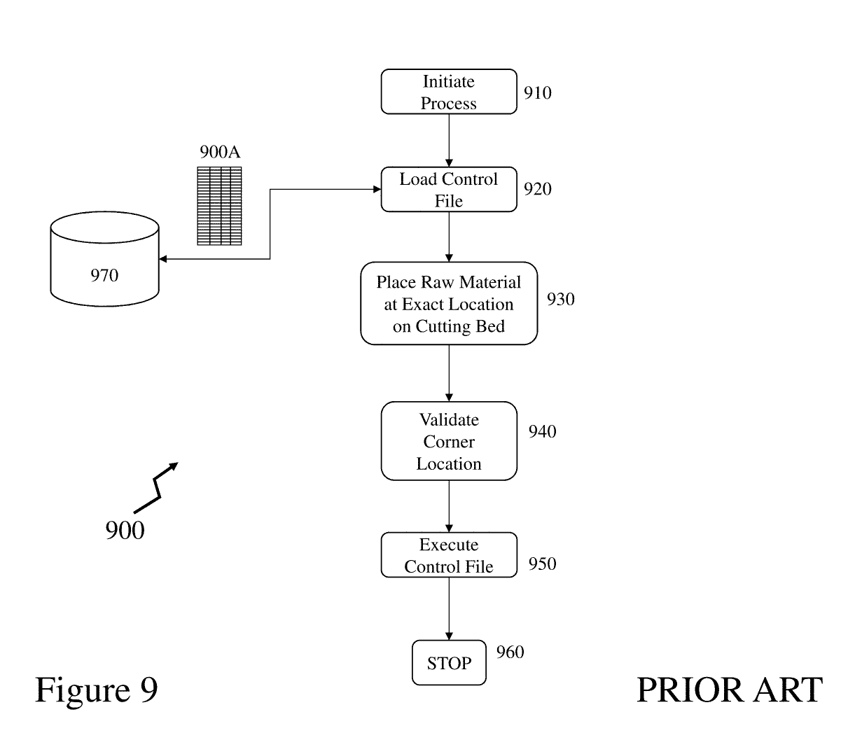

Now referring to FIG. 9 there is depicted a process flow 900 for a prior art CNC machine tool relating to the positioning of the raw material and processing to form the piece-part. As depicted the process flow 900 comprises the following steps:
Step 910 wherein the process is initiated;
Step 920 where the control file 900A is retrieved from a server 970;
Step 930 wherein the raw material is placed at an exact predetermined location on the cutting bed;
Step 940 wherein the process validates the corner location;
Step 950 wherein the process executes the control file 900A; and
Step 960 wherein the process terminates.

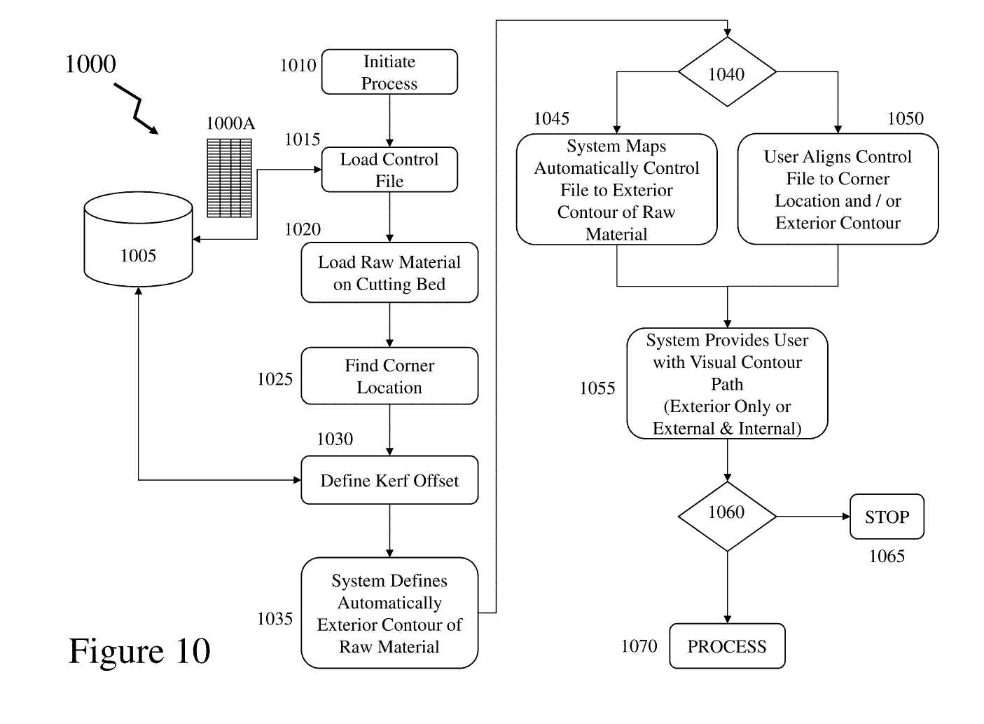

Now referring to FIG. 10 there is depicted a process flow 1000 according to an embodiment of the invention which comprises the following steps:
Step 1010 where the process is inititiated;
Step 1015 where the controller loads the control file 1000A from memory 1005;
Step 1020 where the raw material is loaded to the cutting bed but without use of dedicated stops, predetermined dimension starting raw material etc.;
Step 1025 where the system exploits machine vision to locate a corner of the raw material;
Step 1030 wherein the system defines a kerf offset such as, for example, by retrieval from memory 1005;
Step 1035 wherein the system automatically defines the exterior contour of the raw material and adjusts for the kerf offset retrieved in step 1030;
Step 1040 where the process either establishes automatic mode and proceeds to step 1045 or operator mode and proceeds to step 1050;
Step 1045 where the controller seeks to automatically map the control file to the exterior contour of the raw material to determine whether the piece-part profile fits within the exterior contour;
Step 1050 where the controller seeks to use the operator to map the control file to the exterior contour of the raw material to determine whether the piece-part profile fits within the exterior contour;
Step 1055 wherein based upon the results of either step 1045 or step 1050 the system executes a traversal of the exterior contour of the piece-part defined by the control file 1000A;
Step 1060 wherein the process establishes whether any issues with the traversal of the exterior contour of the piece-part defined by the control file 1000A were identified either by operator and/or machine vision-contact profiling;
Step 1065 wherein an issue causes the process to stop; and
Step 1070 wherein the process executes the control file 1000A.

The traversal of the exterior contour of the piece-part defined by the control file 1000A may be undertaken solely through providing the user with visual information through a GUI or it may be solely through processing acquired image content or solely through contact of a measurement tip with the raw material or it may be via a combination of these. The visual information may be acquired camera images as the camera is traversed relative to the raw material which are displayed wherein the CNC machine adds an overlay depicting the external contour of the piece part or a marker for the edge of the piece part with or without the kerf applied.

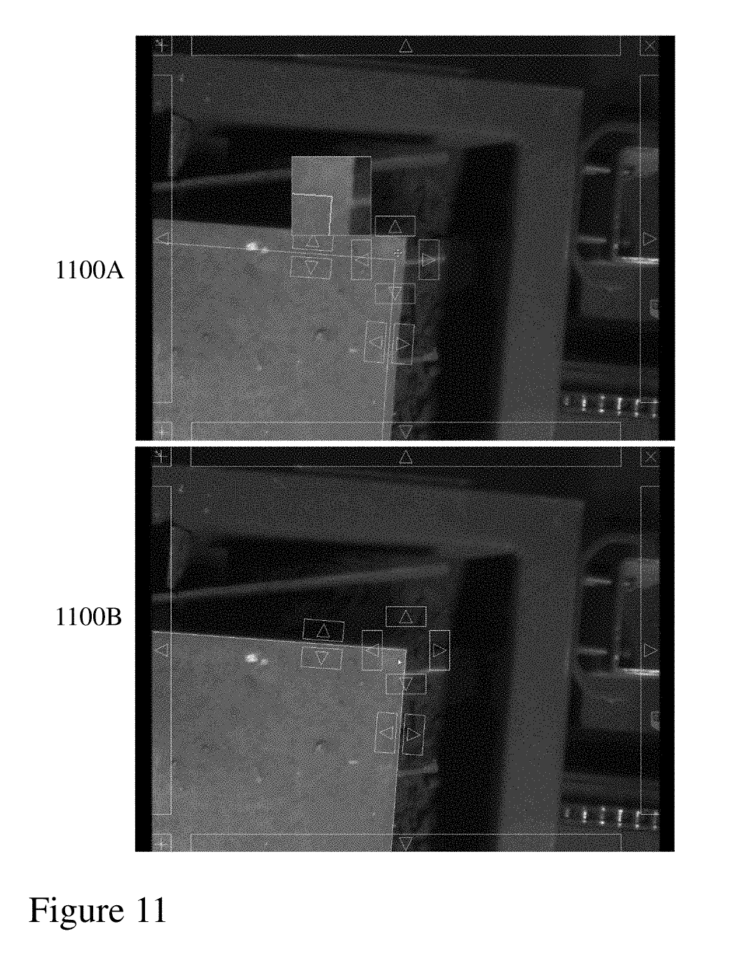

Now referring to FIG. 11 there are depicted first and second images 1100A and 1100B respectively for a corner determination step such as step 1025 in FIG. 10. In first image 1100A the system has identified a corner and moved the camera/raw material to a first alignment accuracy wherein the operator can then adjust the offsets in laterally and rotationally to establish the corner of the raw material in second image 1100B.

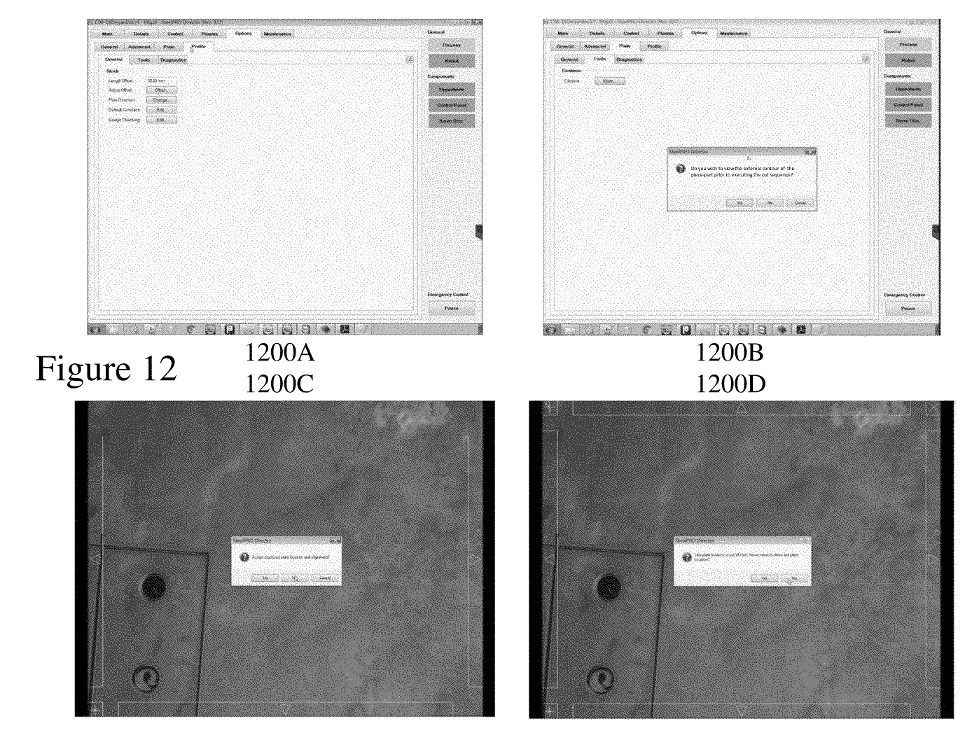

Referring to FIG. 12 there are depicted first to fourth images 1200A to 1200D respectively relating to GUI images presented to a user within a process flow such as depicted in FIG. 10. First image 1200A depicts an interface screen wherein the user can adjust options including for example the length offset which is currently set to 10.00 mm but can be adjusted. For example, the user may be seeking to exploit a piece of raw material which has a long delivery lead time and hence may reduce the kerf to below a lower limit normally established in order to seek to obtain the part against a tight customer delivery requirement. Second image 1200B depicts a user interface screen providing the option for the operator to view the external contour of the piece-part prior to executing the cutting sequence. This may be an option added to the process flow 1000 in FIG. 10 or the process may automatically default to providing this or performing a physical determination of the external contour. Third image 1200C depicts a user prompt within the GUI during the process flow of FIG. 10 wherein the user can accept the plate location and alignment relative to the control file. Fourth image 1200D represents a user prompt within the GUI wherein the camera zoom is currently too high to display the entire piece-part and hence the system gives the user the option to show the last plate location or this may be a sequence of jogged movements to traverse the external contour of the piece-part.

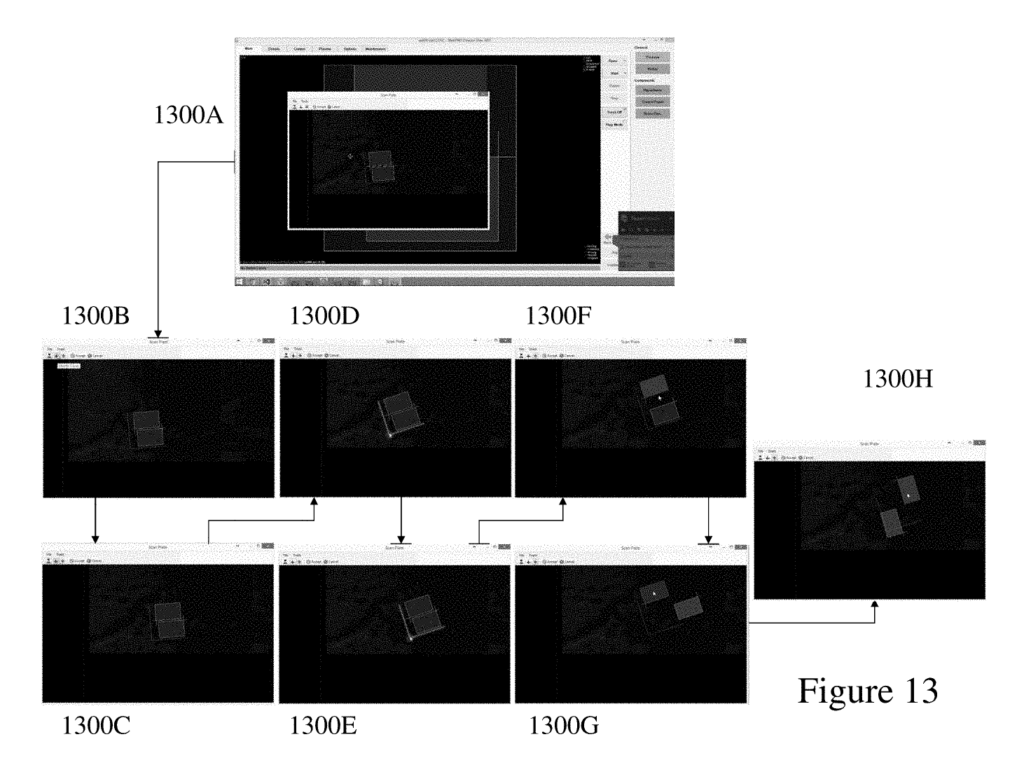

Referring to FIG. 13 there are depicted first to seventh images 1300B to 1300H presented to a user via a GUI 1300A during their manipulation of the control file based upon the determined external geometry of the raw material. Within the process flow 1000 in FIG. 10 the controller seeks to fit the external contour of the piece-part within the raw material based upon determining a corner of the raw material and the relationship of the control file to such a corner. Accordingly, first to seventh images 1300B to 1300H depict:
First image 1300B wherein the initial control file is displayed;
Second image 1300C wherein the control file is laterally offset within the field of view;
Third image 1300D wherein the control file is rotated;
Fourth image 1300E wherein the control file is laterally offset again;
Fifth image 1300F wherein the control file is manipulated to move one element relative to the other vertically;
Sixth image 1300G wherein the control file is manipulated to move one element relative to the other laterally;
Seventh image 1300H wherein the resulting offset elements of the control file are rotated again.

Whilst the discussions presented supra in respect of FIGS. 1 to 13 have been primarily presented with respect to settings of laser welding and plasma cutting systems. However, it would be apparent to one of skill in the art that the methodologies may alternatively be associated with a tool rather than the machine or with respect to a consumable of a tool and/or machine. Further, these processes and methodologies may also be applied to range of other manufacturing processes and/or machines including, but not limited to, machining, milling, welding, cutting, forming, welding, and 3D printing with processes exploiting additive and/or removal processes such as plasma, laser, thermal, fluid etc.

Within embodiments of the invention standard process libraries may be updated such as described by the inventor within U.S. patent application Ser. No. 15/266,404 filed Sep. 15, 2016 entitled “Client Initiated Vendor Verified Tool Setting.”

Within embodiments of the invention the operator may exploit one or more standard templates to define a control file to fit a piece of raw material or alternatively create a control file and then exploit the processes as described with respect to embodiments of the invention to verify/execute them and achieve finished processing with reduced processing time. Such templates may be as described by the inventor within U.S. patent application Ser. No. 15/450,189 filed Mar. 6, 2017 entitled “Direct Client Initiated CNC Tool Setting.”

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof. Databases as referred to herein may also refer to digital repositories of content or other digitally stored content within a collection which may be indexed or non-indexed.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
retrieving a control file for transmission to a computer numerical control (CNC) machine;
dividing the control file into a plurality N control sub-files, wherein N≥3 and N is an integer;
transmitting the first control file;
transmitting the second control file;
receiving a complete signal for the first control file; and
modifying and transmitting the third control file in dependence upon the complete signal for the first control file.

2. The method according to claim 1, further comprising
repeating the steps of:
receiving an I^{th} complete signal; and
modifying and transmitting an (I+2)^{th} control file in dependence upon the complete signal for the I^{th} control file; until
all N control files have been sent.

3. A method comprising:
a) retrieving a control file for transmission to a computer numerical control (CNC) machine comprising a plurality N control lines, wherein N≥3 and N is an integer;
b) transmitting control lines until a first complete signal is received;
c) modifying and transmitting subsequent control lines in dependence upon the received first complete signal;
d) receiving further complete signals;
e) modifying and transmitting subsequent control lines in dependence upon the last complete signal until a new complete signal is received; and
f) continuing until the control file has been sent.

4. A method comprising:
a) establishing upon a computer numerical control (CNC) machine file a control file for execution relating to a piece part to be formed from a piece of raw material;
b) establishing upon the CNC machine a corner of the piece of raw material;
c) establishing a kerf relating to forming the piece part;
d) executing an inspection sequence of the piece of raw material based upon the external contour of the piece part defined by the control file and the kerf;
e) determining whether the external contour of the piece part fits within the piece of raw material;
f) upon a positive determination forming the piece part from the piece of raw material.

5. The method according to claim 4, wherein
executing the inspection sequence comprises traversing a camera forming part of the CNC machine relative to the piece of raw material; and
displaying upon a display the acquired images from the camera together with an indication of the external contour of the piece part at least one of with and without the kerf.
